(19) United States
(12) Patent Application Publication
(10) Pub. No.: US 2007/0279698 A1
(43) Pub. Date: Dec. 6, 2007

(54) Network facsimile apparatus and network facsimile system

(75) Inventor: Toru Ichiki, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/802,294

(22) Filed: May 22, 2007

(30) Foreign Application Priority Data
Jun. 1, 2006 (JP) JP2006-153063

(51) Int. Cl. H04N 1/00

(52) U.S. Cl. 358/400

(57) ABSTRACT

There is described a network facsimile apparatus, which makes it possible to alleviate burdens of the user in charge of operations for confirming the transferring status and for acquiring the image data, when the image data are transferred to another receiver by employing the redirect function. The network facsimile apparatus, serving as a caller that establishes a session based on a Session Initiation Protocol to conduct image data communicating operations with other apparatuses serving as a first callee, a second callee and a third callee, comprises: a receiving section to receive a terminal identifying information of the caller, a first terminal identifying information of the first callee and the image data, when the first callee is incapable of receiving the image data sent from the caller; and a display section to display the terminal identifying information of the caller and the first terminal identifying information of the first callee.

This application is based on Japanese Patent Application No. 2006-153063 filed on Jun. 1, 2006 with Japan Patent Office, the entire content of which is hereby incorporated by reference.

### BACKGROUND OF THE INVENTION

The present invention relates to a network facsimile apparatus and a network facsimile system, in which a facsimile transmission is conducted through a communication path established by the session controlling operation based on the Session Initiation Protocol (SIP).

As one of communication methods for the network facsimile transmission, there has been a method for transmitting image data between a transmitter and a receiver, which are coupled to each other through a network, such as the Internet, etc., in the peer-to-peer network architecture by employing the Session Initiation Protocol.

According to such the Session Initiation Protocol, identification information for specifying a facsimile apparatus installed in a sender site (namely, a SIP address, for instance, address information based on a FAX telephone number of the public telephone line, a user name of the sender, etc.) and an IP address (Internet Protocol address) are registered and stored into a server called an IP server installed in the network, which is constituted by a proxy server, a registration server, a location server, a redirect server, etc., while correlating them with each other. Then, when the transmitter requests the SIP server to connect it to the receiver with the SIP address, the SIP server retrieves the IP address corresponding to the SIP address received, in order to achieve the call connection between the transmitter and the receiver, addressed by the transmitter, by using the IP address retrieved.

Further, the Session Initiation Protocol provides a redirecting function for temporarily changing the IP address, to be registered while correlating it with the SIP address, to a substitute address. After that, when the transmitter requests the SIP server to connect it to the receiver with the SIP address, for which the substitute address is temporarily established, the SIP server notifies the transmitter of the fact that the substitute address is currently and temporarily established and the concerned substitute address as a redirect response.

Sometimes, an address indicated by the substitute address, notified as such the redirect response, would represent a receiver, which is inconformity with the intention of the sender. Accordingly, to prevent such the erroneous facsimile transmission that is not intended by the sender, Patent Document 1 (Tokkai 2005-94662, Japanese Non-Examined Patent Publication) sets forth a network facsimile apparatus that automatically suspends the current communication when the redirect response is notified. Further, according to the abovementioned network facsimile apparatus, permission addresses, which are permitted as the substitute addresses, are registered in advance at the sender site, so that, only when the substitute address notified as the redirect response coincides with one of the permission addresses, the concerned facsimile transmission is automatically transferred to the receiver represented by this substitute address.

According to the abovementioned technology, since the image data are not transferred to the receiver site represented by a substitute address, other than the substitute addresses established in advance as the permission addresses, even when the redirect response is received, it becomes possible to prevent the erroneous facsimile transmission that is not intended by the sender. However, even if it is permission address that is employed in the sender site, once the operation for transmitting the image data to the forwarding address site represented by the substitute address, serving as a permission address, is completed, it is impossible for the receiver in the forwarding address site to discriminate whether the image data are originally directed to the own receiver site or transferred according to the substitute address. Therefore, if the receiver indiscriminately conducts the printing operations of the images based on the image data received, problems in regard to the Secret maintenance, etc would arise.

Further, when a transfer mode, in which the redirect function allows the facsimile image data to be transferred to another receiver, is temporarily established, it has been inconvenient for the operator to take the trouble to go to the forwarding address site at which the receiver is installed, in order to confirm whether or not the transferring operation to the other receiver has been actually conducted during the transfer mode, or in order to acquire the image data transferred and collected into the other receiver.

### SUMMARY OF THE INVENTION

To overcome the abovementioned drawbacks in conventional network facsimile apparatuses and network facsimile systems, it is one of objects of the present invention to provide a network facsimile apparatus and a network facsimile system, which makes it possible to alleviate burdens to be incurred to the user in charge of the confirming operation of the transferring status and the acquiring operation of the image data when the image data are transferred to another receiver by employing the redirect function.

Accordingly, at least one of the objects of the present invention can be attained by the network facsimile apparatus and the network facsimile system described as follows.

(1) According to an aspect of the present invention, a network facsimile apparatus that conducts a session controlling operation based on a Session Initiation Protocol; when a first reception terminal device is incapable of receiving image data sent from the network facsimile apparatus serving as a transmission terminal device, the network facsimile apparatus comprises: a receiving section to receive a terminal identifying information in respect to the transmission terminal device, a first terminal identifying information in respect to the first reception terminal device and the image data; and a display section to display the terminal identifying information in respect to the transmission terminal device and the first terminal identifying information in respect to the first reception terminal device.

(2) According to another aspect of the present invention, a network facsimile apparatus that conducts a session controlling operation based on a Session Initiation Protocol; when a first reception terminal device is incapable of receiving image data sent from the network facsimile apparatus serving as a transmission terminal device, the network facsimile apparatus comprises: a transmitting section to transmit a terminal identifying information in respect to the transmission terminal device and a first terminal identifying information in respect to the first reception terminal device and the image data to a second reception terminal device.

(3) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a receiving section to receive a terminal identifying information in respect to the transmission terminal device, substitute transmission indicating information indicating that a current transmission is a substitute transmission and the image data; and a control section to conduct controlling operation for storing the image data into a storage section based on the substitute transmission indicating information received by the receiving section without printing an image represented by the image data.

(4) According to still another aspect of the present invention, a network facsimile apparatus that conducts a session controlling operation based on a Session Initiation Protocol; when a first reception terminal device is incapable of receiving image data sent from the network facsimile apparatus serving as a transmission terminal device, the network facsimile apparatus comprises: a transmitting section to transmit a terminal identifying information in respect to the transmission terminal device, substitute transmission indicating information indicating that a current transmission is a substitute transmission and the image data to a second reception terminal device.

(5) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a receiving section to receive a terminal identifying information in respect to the transmission terminal device, a first terminal identifying information in respect to the first reception terminal device and the image data; and a transmitting section to transmit information of the image data, which relate to the first terminal identifying information in respect to the first reception terminal device, to the first reception terminal device, in response to a signal sent from the first reception terminal device.

(6) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a receiving section to receive a terminal identifying information in respect to the transmission terminal device, a first terminal identifying information in respect to the first reception terminal device and the image data; and a transmitting section to transmit information of the image data, which relate to the first terminal identifying information in respect to the first reception terminal device, to a third reception terminal device, in response to a signal sent from the third reception terminal device.

(7) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a receiving section to receive a terminal identifying information in respect to the transmission terminal device, a first terminal identifying information in respect to the first reception terminal device and the image data; and a transmitting section to transmit the image data, which relate to the first terminal identifying information in respect to the first reception terminal device, to the first reception terminal device, in response to a signal sent from the first reception terminal device.

(8) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a receiving section to receive a terminal identifying information in respect to the transmission terminal device, a first terminal identifying information in respect to the first reception terminal device and the image data; and a transmitting section to transmit the image data, which relate to the first terminal identifying information in respect to the first reception terminal device, to a third reception terminal device, in response to a signal sent from the third reception terminal device.

(9) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a request signal transmitting section to transmit a request signal for transmitting information of the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device, in it.

(10) According to still another aspect of the present invention, a network facsimile apparatus that conducts a session controlling operation based on a Session Initiation Protocol; when a first reception terminal device is incapable of receiving image data sent from a transmission terminal device, the network facsimile apparatus comprises: a request signal transmitting section to transmit a request signal for transmitting the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device in it.

(11) According to still another aspect of the present invention, a network facsimile apparatus that conducts a session controlling operation based on a Session Initiation Protocol; when the network facsimile apparatus serving as a first reception terminal device is incapable of receiving image data sent from a transmission terminal device, the network facsimile apparatus comprises: a request signal transmitting section to transmit a request signal for transmitting information of the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device, in it.

(12) According to still another aspect of the present invention, a network facsimile apparatus that conducts a session controlling operation based on a Session Initiation Protocol; when the network facsimile apparatus serving as a first reception terminal device is incapable of receiving image data sent from a transmission terminal device, the network facsimile apparatus comprises: a request signal transmitting section to transmit a request signal for transmitting the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device in it.

(13) According to still another aspect of the present invention, a network facsimile system, comprises: a transmission terminal apparatus serving as a caller; a first reception terminal apparatus serving as a first callee; and a second reception terminal apparatus serving as a second callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, a first terminal identifying information in respect to the first callee and the image data to the second callee, when the determining section determines that the first callee is incapable of receiving the image data; and wherein the second callee includes: a receiving section to receive the terminal identifying information in respect to the caller, the first terminal identifying information in respect to the first callee and the image data; and a display section to display the terminal identifying information in respect to the caller and the first terminal identifying information in respect to the first callee, received by the receiving section.

(14) According to still another aspect of the present invention, a network facsimile system, comprises: a transmission terminal apparatus serving as a caller; a first reception terminal apparatus serving as a first callee; and a second reception terminal apparatus serving as a second callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, substitute transmission indicating information, which indicate that a current transmission is a substitute transmission and the image data to the second callee, when the determining section determines that the first callee is incapable of receiving the image data; and wherein the second callee includes: a receiving section to receive the terminal identifying information in respect to the caller, the substitute transmission indicating information and the image data; and wherein the second callee includes: a storage section to store the image data in it; and a control section to store the image data into the storage section based on the substitute transmission indicating information received by the receiving section without printing an image represented by the image data.

(15) According to still another aspect of the present invention, a network facsimile system, comprises: a transmission terminal apparatus serving as a caller; a first reception terminal apparatus serving as a first callee; and a second reception terminal apparatus serving as a second callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, a first terminal identifying information in respect to the first callee and the image data to the second callee, when the determining section determines that the first callee is incapable of receiving the image data; and wherein the second callee includes: a receiving section to receive the terminal identifying information in respect to the caller, the first terminal identifying information in respect to the first callee and the image data; and wherein the first callee includes: a request signal transmitting section to transmit a request signal for transmitting information of the image data, which relate to the first terminal identifying information in respect to the first callee, to the second callee; and wherein the second callee further includes: a transmitting section to transmit the information of the image data, which relate to the first terminal identifying information in respect to the first callee, to the first callee in response to the request signal sent from the first callee.

(16) According to still another aspect of the present invention, a network facsimile system, comprises: a transmission terminal apparatus serving as a caller; a first reception terminal apparatus serving as a first callee; a second reception terminal apparatus serving as a second callee; and a third reception terminal apparatus serving as a third callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, a first terminal identifying information in respect to the first callee and the image data to the second callee, when the determining section determines that the first callee is incapable of receiving the image data; and wherein the second callee includes: a receiving section to receive the terminal identifying information in respect to the caller, the first terminal identifying information in respect to the first callee and the image data; and wherein the third callee includes: an inputting section to input the first terminal identifying information in respect to the first callee; and a request signal transmitting section to transmit a request signal for transmitting information of the image data, which relate to the first terminal identifying information in respect to the first callee, to the second callee; and wherein the second callee further includes: a transmitting section to transmit the information of the image data, which relate to the first terminal identifying information in respect to the first callee, to the third callee in response to the request signal sent from the third callee.

(17) According to still another aspect of the present invention, a network facsimile system, comprises: a transmission terminal apparatus serving as a caller; a first reception terminal apparatus serving as a first callee; and a second reception terminal apparatus serving as a second callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, a first terminal identifying information in respect to the first callee and the image data to the second callee, when the determining section determines that the first callee is incapable of receiving the image data; and wherein the second callee includes: a receiving section to receive the terminal identifying information in respect to the caller, the first terminal identifying information in respect to the first callee and the image data; and wherein the first callee includes: a request signal transmitting section to transmit a request signal for transmitting the image data, which relate to the first terminal identifying information in respect to the first callee, to the second callee; and wherein the second callee further includes: a transmitting section to transmit the image data, which relate to the first terminal identifying information in respect to the first callee, to the first callee in response to the request signal sent from the first callee.

(18) According to yet another aspect of the present invention, a network facsimile system, comprises: a transmission terminal apparatus serving as a caller; a first reception terminal apparatus serving as a first callee; a second reception terminal apparatus serving as a second callee; and a third reception terminal apparatus serving as a third callee; wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and wherein the caller includes: a determining section to determine whether or not the first callee is capable of receiving the image data sent form the caller itself; and a transmitting section to transmit a terminal identifying information in respect to the caller, a first terminal identifying information in respect to the first callee and the image data to the second callee, when the determining section determines that the first callee is incapable of receiving the image data; and wherein the second callee includes: a receiving section to receive the terminal identifying information in respect to the caller, the first terminal identifying information in respect to the first callee and the image data; and wherein the third callee includes: an inputting section to input the first terminal identifying information in respect to the first callee; and a request signal transmitting section to transmit a request signal for transmitting the image data, which relate to the first terminal identifying information in respect to the first callee, to the second callee; and wherein the second callee further includes: a transmitting section to transmit the image data, which relate to the first terminal identifying information in respect to the first callee, to the third callee in response to the request signal sent from the third callee.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an exemplified configuration of a network facsimile system including a network facsimile apparatus embodied in the present invention;

FIG. 2 shows an explanatory drawing for exemplifying a detailed configuration of a network facsimile system and transactions between methods and responses;

FIG. 3 shows a communication procedure of a facsimile transmission conducted from a network facsimile apparatus installed at a sender site to another network facsimile apparatus installed at a receiver site in a network facsimile system;

FIG. 4 shows various kinds of data flows in a network facsimile system embodied in the present invention;

FIG. 5 shows a control data table listing control data items to be attached to a header of each text of E-mails;

FIG. 6 shows a flowchart of a transmitting operation to be conducted by a transmitting terminal device;

FIG. 7 shows a flowchart of a SMTP transmission processing to be conducted in each of a transmitting terminal device, a first receiving terminal device, a second receiving terminal device and a third receiving terminal device;

FIG. 8 shows a flowchart of a SMTP reception processing to be conducted in each of a transmitting terminal device, a first receiving terminal device, a second receiving terminal device and a third receiving terminal device;

FIG. 9 shows a flowchart of processing for displaying a reception list on an operational display section; and

FIG. 10(a), FIG. 10(b), FIG. 10(c) and FIG. 10(d) show exemplified screens to be displayed on an operational display section of a second receiving terminal device.

### DETAILED DESCRIPTION OF THE PREFERRED EMBODIMENT

Referring to the drawings, the embodiment of the present invention will be detailed in the following.

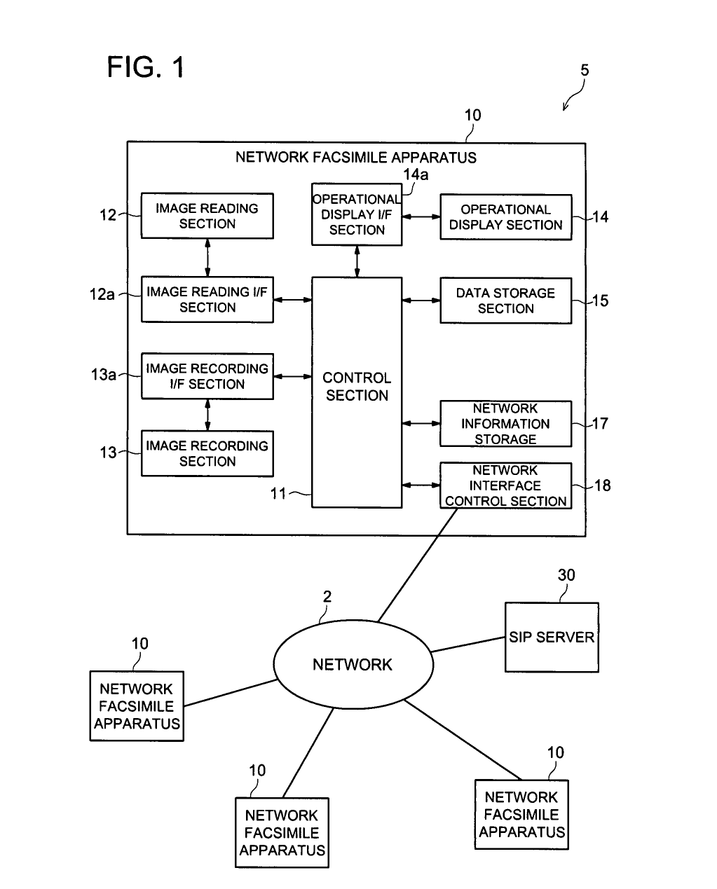

FIG. 1 shows an exemplified configuration of a network facsimile system 5 including a network facsimile apparatus 10 embodied in the present invention. The network facsimile system 5 is such a facsimile communication system that is so constituted that the call connection is achieved by employing the Session Initiation Protocol, and facsimile image data are communicated between transmitters and receivers, which are coupled to each other in the peer-to-peer network architecture, through a network 2. The network facsimile system 5 is structured by connecting a SIP server 30 and a plurality of network facsimile apparatuses 10 to the network 2, such as the Internet, etc.

The network facsimile apparatus 10 serves as a network connectable facsimile apparatus that conducts a session controlling operation based on the Session Initiation Protocol, and is constituted by: a control section 11 including a CPU (Central Processing Unit) as its main section; an image reading section 12 for optically reading a document so as to acquire image data; an image recording section 13 for printing an image onto a recording medium; an operational display section 14 for displaying an operational screen and for receiving operations operated by the user; a data storage section 15 including data storages for storing the image data and a hard disc drive; a network information storage 17 for storing various kinds of information pertaining to the communications for which the Session Initiation Protocol is employed; a network I/F control section 18 having a function for exchanging various kinds of data between the SIP server 30 and other terminal devices through the network 2; etc.

Further, the image reading section 12, the image recording section 13 and operational display section 14 are coupled to the control section 11 through an image reading I/F section 12a, an image recording I/F section 13a and an operational display I/F section 14a, respectively.

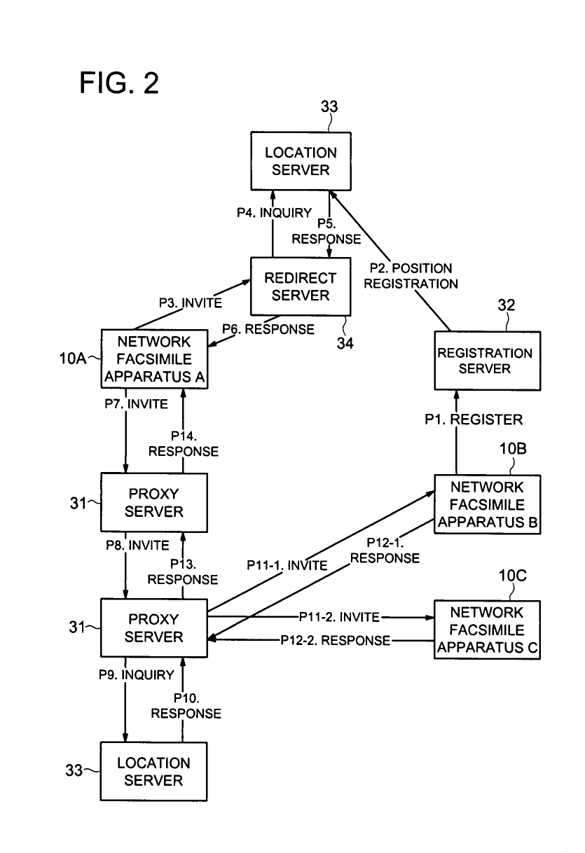

As shown in FIG. 2, the SIP server 30 is constituted by a plurality of various servers including, for instance, a proxy server 31, a registration server 32, a location server 33, a redirect server 34, etc. It is applicable, however, that various functions included in the above plurality of various servers are integrated into a single server. In the Session Initiation Protocol architecture, establishment/end of the session is achieved by exchanging methods and responses corresponding to them.

The registration server 32 is such a server that accepts a registration request, sent from specific one of the plurality of network facsimile apparatuses 10, for registering its positional information on the network 2. In the positional information, the SIP address of the own apparatus (for instance, the own telephone number on the public telephone line (FAX number) or the address information based on the user name, the apparatus name, etc., allotted to the apparatus concerned), the address information of the own apparatus on the network 2 (herein, IP address of the own apparatus), etc. are correlated with each other.

The location server 33 is provided with a database function for accumulating and storing the positional information accepted by the registration server 32 into it, so as to provide the positional information concerned, in response to the inquiry sent from the proxy server 31 or the redirect server 34. The proxy server 31 relays the methods and the responses sent from the network facsimile apparatus 10 to the next server.

Receiving a connecting request with a SIP address of the network facsimile apparatus 10 at a receiver site, sent from the other network facsimile apparatus 10 at a sender site, the SIP server 30 retrieves a specific IP address correlated to the SIP address from the positional information stored in the location server 33, and employs the specific IP address retrieved, so as to achieve the call connection between the network facsimile apparatus 10 at a receiver site and the other network facsimile apparatus 10 at a sender site.

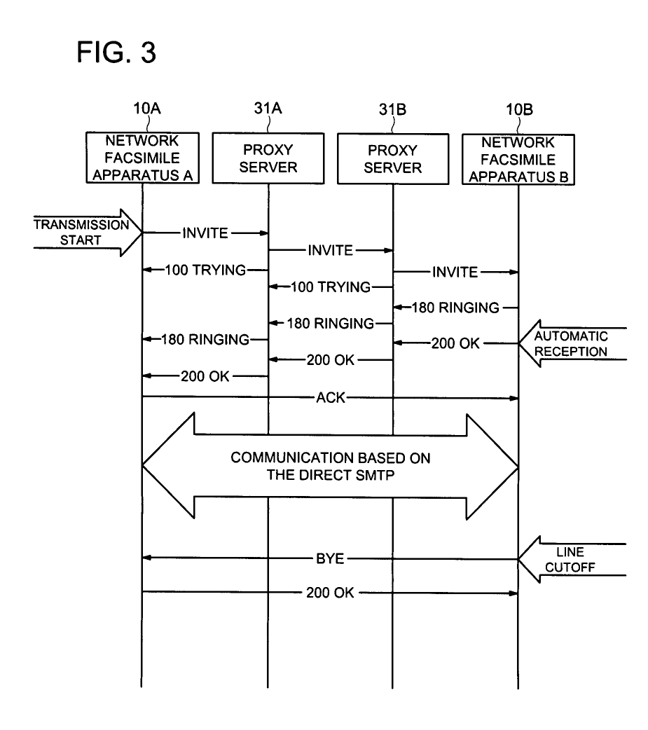

FIG. 3 shows a communication procedure of a facsimile transmission conducted from the network facsimile apparatus 10A at a sender site (hereinafter, also referred to as a caller) to the network facsimile apparatus 10B at a receiver site (hereinafter, also referred to as a callee) in the network facsimile system 5. At first, the network facsimile apparatus 10A at the sender site sends the INVITE method to the network facsimile apparatus 10B at the receiver site, so as to urge an establishment of the session concerned. The proxy server 31A and the proxy server 31B relay the INVITE method so that the INVITE method arrives into the network facsimile apparatus 10B. Further, each of the proxy server 31A and the proxy server 31B also sends a response code 100TRYING, indicating a current status of transferring the request to the following stage, back to the caller that originally sent the INVITE method received.

When receiving the INVITE method, the network facsimile apparatus 10B sends a response code 180RINGING back to the network facsimile apparatus 10A, and further, when accepting receipt, sends a response code 2000K back to the network facsimile apparatus 10A. The proxy server 31B and the proxy server 31A relay both the response code 180RINGING and the response code 2000K, so that those arrive into the network facsimile apparatus 10B. Receiving the response code 2000K, the network facsimile apparatus 10A sends the ACK method directly to the network facsimile apparatus 10B. Then, the session is established.

After the session is established, the facsimile transmission of the image data is conducted by employing an arbitral protocol. For instance, a protocol conformity with the Recommendation T.37 or T.38 of ITU-T (International Telecommunication Union—Telecommunication sector) would be employed. In this example, the communication is conducted by employing the direct SMTP (Simple Mail Transfer Protocol).

When the facsimile transmission is completed, the network facsimile apparatus 10B, serving as a callee, sends the BYE method to the network facsimile apparatus 10A, serving as a caller. In response to the BYE method, the network facsimile apparatus 10A sends the response code 2000K to the callee, to finalize the session.

Next, returning to FIG. 2, the redirect function will be detailed in the following.

One of the plurality of network facsimile apparatuses 10 (for instance, the network facsimile apparatus 10B shown in FIG. 2), can establish such a redirect mode that makes it possible to transfer the facsimile transmission, originally directed to the network facsimile apparatus 10B itself, to another network facsimile apparatus 10C (redirect address), by temporarily registering specific information of the other apparatus other than the network facsimile apparatus 10B itself (where, the IP address of the network facsimile apparatus 10C) into the location server 33 and the redirect server 34 (indicated by arrows P1 and P2 shown in FIG. 2), while correlating the IP address of the other apparatus with that of the network facsimile apparatus 10B itself (the specific information of the network facsimile apparatus 10B itself, and hereinafter, the abovementioned registration is referred to as a redirect setting).

When the SIP server 30 receives a request of connection with the network facsimile apparatus 10B, in which such the redirect setting is established, from the network facsimile apparatus 10A serving as a caller (indicated by arrow P3), the SIP server 30 sends an inquiry to the location server 33 through the redirect server 34 (indicated by arrows P4 and P5), and then, notifies the network facsimile apparatus 10A, serving as the caller, of the specific information of the redirect address (namely, network facsimile apparatus 10C) registered while correlating to the SIP address of the network facsimile apparatus 10B (IP address of the other apparatus) as the redirect response (indicated by arrow P6).

The network facsimile apparatus 10A reissues the INVITE method to the IP address of the other apparatus notified by the redirect response, so as to established the session with the network facsimile apparatus 10C (the redirect address), which is established as the substitute apparatus for the network facsimile apparatus 10B originally nominated as the callee (indicated by arrows P7 through P14), and then, can transmits the image data to the network facsimile apparatus 10C.

Next, in the network facsimile system 5, the operations, to be conducted in the case that facsimile information are transmitted to the receiver in which the redirect setting is established, will be detailed in the following.

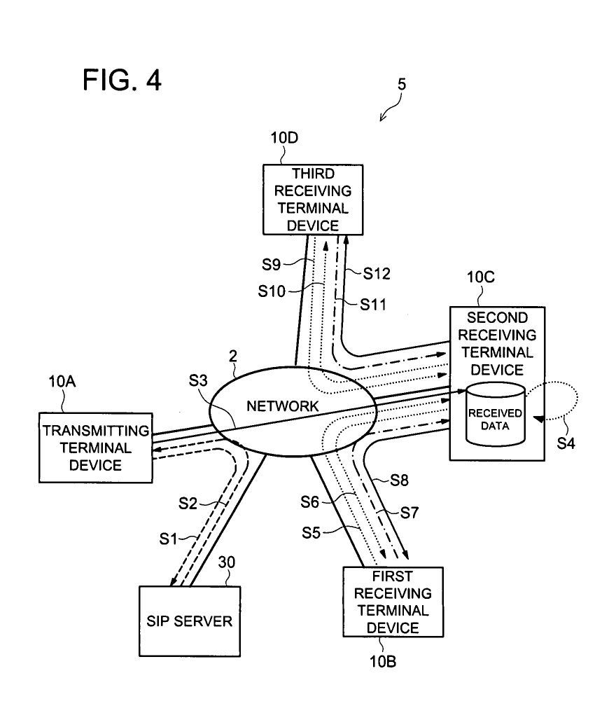

FIG. 4 shows various kinds of data flows in the network facsimile system 5. Hereinafter, a transmitting terminal device 10A, serving as a caller, represents a network facsimile apparatus at a sender site; a first receiving terminal device 10B, serving as a first callee, represents another network facsimile apparatus at an original receiver site, to which the transmitting terminal device 10A initially tried to transmit image data; a second receiving terminal device 10C, serving as a second callee, represents still another network facsimile apparatus designated as the redirect address of the first transmitting terminal device 10B; and a third receiving terminal device 10D, serving as a third callee, represents yet another network facsimile apparatus other than the network facsimile apparatuses defined in the above. Hereinafter, the term of “callee” is employed as a general term of the first callee, the second callee and the third callee.

Although the transmitting terminal device 10A sends a request of connection with the first receiving terminal device 10B to the SIP server 30 (indicated by arrow S1), since the redirect setting, which designates the second receiving terminal device 10C as the redirect address, is established in the first receiving terminal device 10B, the SIP server 30 notifies the transmitting terminal device 10A of the redirect response (indicated by arrow S2). Receiving the redirect response, a determining section (not shown in the drawings) included in the transmitting terminal device 10A determines that the first receiving terminal device 10B cannot receive the facsimile data, and accordingly, the transmitting terminal device 10A conducts a substitute transmission for transmitting the facsimile data to the second receiving terminal device 10C notified by the redirect response (indicated by arrow S3).

In the abovementioned substitute transmission, the transmitting terminal device 10A transmits terminal identifying information in regard to the transmitting terminal device 10A itself, other terminal identifying information in regard to the first receiving terminal device 10B and the image data to the second receiving terminal device 10C. Any kind of information, capable of specifying the terminal device concerned, could be employed as the terminal identifying information, and for instance, the SIP address can be employed. Alternatively, other than the SIP address, the IP address, a name or a number allotted to the terminal device concerned, etc. are also available as the terminal identifying information. Further, in the substitute transmission, the information in respect to the image data, for instance, a name of document, etc., would be also transmitted.

When receiving the image data transmitted in the substitute transmission mode, from the viewpoint of the substitute transmission, the second receiving terminal device 10C merely stores the received image data into the data storage section 15 and merely stores the information in respect to the image data into the network information storage 17, without conducting the printing operation unless otherwise instructed or operated. Accordingly, by disabling an automatic implementation of the printing operation as mentioned in the above, it becomes possible to maintain a security of the image data transmitted in the substitute transmission mode. By visiting the second receiving terminal device 10C and conducting the predetermined input operations from the operational display section 14, it becomes possible for the user to display a list of the information in respect to the image data transmitted in the substitute transmission mode onto the operational display section 14 of the second receiving terminal device 10C or to make the image recording section 13 print an image based on the image data received in the substitute reception mode (indicated by arrow S4). According to the abovementioned procedure, even when the first receiving terminal device 10B cannot receive the image data or cannot print the image based on the image data, it becomes possible to utilize the image data and the information in respect to the image data at another terminal device, which receives them in the substitute reception mode.

Further, the first receiving terminal device 10B has a function for transmitting a command signal for requesting the second receiving terminal device 10C to transmit the list of the information in respect to the image data received by the second receiving terminal device 10C serving as a substitute for the first receiving terminal device 10B itself, to the second receiving terminal device 10C (list request, indicated by arrow S5). Since the first receiving terminal device 10B memorizes information indicating what terminal device is designated as the redirect address, the first receiving terminal device 10B recognizes the destination of the list request based on the information concerned.

On the other hand, the second receiving terminal device 10C has a function for transmitting a list response including information in respect to the image data concerned (indicated by arrow S6) to the first receiving terminal device 10B, when receiving the list request from the first receiving terminal device 10B.

According to the functions mentioned in the above, it becomes possible for the user to employ the first receiving terminal device 10B located remote from the second receiving terminal device 10C for confirming whether or not the image data transferred to the second receiving terminal device 10C exist, and/or what kind of image data are received by the second receiving terminal device 10C in the substitute reception mode, without actually visiting the second receiving terminal device 10C. Such the functions are specifically useful when the inability state of receiving the image data in the first receiving terminal device 10B is eliminated.

The list request includes the terminal identifying information in respect to the first receiving terminal device 10B being an original callee. Based on the terminal identifying information mentioned in the above, the second receiving terminal device 10C selects specific information in respect to the image data, received in the substitute reception mode in which the first receiving terminal device 10B is designated as the redirect address, from various information received in various substitute reception modes, so as to create a list of the specific information. The first receiving terminal device 10B stores the terminal identifying information of the first receiving terminal device 10B itself in the network information storage 17, etc., and transmits list request signals including its own terminal identifying information retrieved in the above.

Any kind of information useful for recognizing a property of image data received in each of various substitute reception modes can be employed as the information in respect to the image data. For instance, an ID or address information of the transmitting terminal device 10A, a name of document, a name of a receiving person, a date and time of substitute reception, a number of pages, a document number, etc. can be cited.

Further, the first receiving terminal device 10B has a function for transmitting a command signal for requesting the second receiving terminal device 10C to transmit the image data, received in the substitute reception mode by the second receiving terminal device 10C serving as a substitute for the first receiving terminal device 10B itself, to the first receiving terminal device 10B, to the second receiving terminal device 10C (transfer request, indicated by arrow S7). Since the first receiving terminal device 10B memorizes information indicating what terminal device is designated as the redirect address, the first receiving terminal device 10B recognizes the destination of the transfer request based on the information concerned.

On the other hand, the second receiving terminal device 10C has a function for transmitting a transfer response including the image data concerned (indicated by arrow S8) to the first receiving terminal device 10B, when receiving the transfer request from the first receiving terminal device 10B. As well as the list request, the image data transfer request includes the terminal identifying information in respect to the first receiving terminal device 10B being an original callee. Based on the terminal identifying information mentioned in the above, the second receiving terminal device 10C identifies the image data, received in the substitute reception mode in which the first receiving terminal device 10B is designated as the redirect address, from various information received in various substitute reception modes.

According to the functions mentioned in the above, it becomes possible for the user to acquire the image data transferred into the second receiving terminal device 10C from the first receiving terminal device 10B located remote from the second receiving terminal device 10C, without actually visiting the second receiving terminal device 10C.

It is applicable that the list request and the transfer request can be automatically transmitted at the time when the first receiving terminal device 10B enters into a receivable state, or transmitted at an arbitral time based on the instruction of the user.

For instance, the first receiving terminal device 10B is provided with a state distinction section (not shown in the drawings) to distinguish whether or not the first receiving terminal device 10B itself is currently capable of receiving the image data (receivable state). When the state distinction section determines that the first receiving terminal device 10B itself is currently capable of receiving the image data, a requesting section (not shown in the drawings) provided in the first receiving terminal device 10B automatically transmits a request command signal (either the list request or the transfer request) to the second receiving terminal device 10C.

Speaking with a concrete example, when the first receiving terminal device 10B itself is currently incapable of receiving the image data due to an occurrence of error, such as a paper jamming, etc., the first receiving terminal device 10B makes the SIP server 30 establish the redirect setting in which the second receiving terminal device 10C is designated as the redirect address. It is preferable that this redirect setting is automatically established by detecting the paper jamming, etc. After that, the state distinction section determines whether or not the error, such as a paper jamming, etc., is eliminated, so that the request command signal (either the list request or the transfer request) in respect to the substitute reception is automatically transmitted to the second receiving terminal device 10C at the time when the error is eliminated and the receivable state is resumed.

According to the controlling procedure mentioned in the above, when the error, such as a paper jamming, etc., is eliminated and the receivable state is resumed, it becomes possible for the first receiving terminal device 10B not only to remotely confirm whether or not the transferring operation has been conducted during the time period in which the receiving operation has been incapable, but also to automatically acquire the image data received in the substitute reception mode from the first receiving terminal device 10B.

Incidentally, even when the state distinction section determines that the first receiving terminal device 10B is in the receivable state, it is applicable that the transmission of the request command signal (either the list request or the transfer request) is banned on the basis of the setting information of the network facsimile apparatus 10. For instance, a time period, during which the transmission of the request command signal (either the list request or the transfer request) is banned, is established, so that both the first receiving terminal device 10B and the second receiving terminal device 10C are controlled not to transmit the request command signal (either the list request or the transfer request) during the above-established time period, even if the receivable state is resumed. It would be effective to employ such the time period for holidays or nighttime.

Further, it is applicable that a result determined by the state distinction section is displayed on a display device, such as the operational display section 14, etc., so that the user can determine whether or not the request command signal (either the list request or the transfer request) should be transmitted, by viewing the above-determined result displayed on the screen of the display device. In this case, the request command signal (either the list request or the transfer request) is transmitted only when a transmitting instruction sent from the user is received through an accepting section, such as the operational display section 14, etc.

Further, the third receiving terminal device 10D has a function for transmitting a command signal for requesting the second receiving terminal device 10C to transmit the list of the information in respect to the image data received by the second receiving terminal device 10C serving as a substitute for the first receiving terminal device 10B, to the second receiving terminal device 10C (list request, indicated by arrow S9). The second receiving terminal device 10C has a function for transmitting a list of information in respect to the image data concerned as a list response (indicated by arrow S10) to the third receiving terminal device 10D, when receiving the list request sent from the third receiving terminal device 10D.

Further, the third receiving terminal device 10D can transmit a command signal for requesting the second receiving terminal device 10C to transmit the image data, received in the substitute reception mode by the second receiving terminal device 10C serving as a substitute for the first receiving terminal device 10B, to the third receiving terminal device 10D, to the second receiving terminal device 10C (transfer request, indicated by arrow S11). While, the second receiving terminal device 10C has a function for transmitting a transfer response including the image data concerned (indicated by arrow S12) to the third receiving terminal device 10D, when receiving the transfer request from the third receiving terminal device 10D. According to the functions mentioned in the above, it becomes possible for the user to confirm whether or not the image data transferred to the second receiving terminal device 10C represented by the redirect address, or what kind of image data are received in the substitute reception mode by the second receiving terminal device 10C, by employing the third receiving terminal device 10D other than the first receiving terminal device 10B, without actually visiting the first receiving terminal device 10B or the second receiving terminal device 10C.

The terminal identifying information of the first receiving terminal device 10B, being an original callee, are inputted into the third receiving terminal device 10D from the operational display section 14 of it. Then, the third receiving terminal device 10D transmits the above-inputted terminal identifying information to the second receiving terminal device 10C. The second receiving terminal device 10C retrieves a specific image data, corresponding to the terminal identifying information included in the request command signal, from image data received in the substitute reception mode, and creates a list of the information in respect to the specific image data retrieved, so as to transmit the list of the information and/or the specific image data to the third receiving terminal device 10D.

Next, processing to be conducted in each of the apparatuses and information to be exchange between the apparatuses in order to implements the operations indicated in FIG. 4, will be detailed in the following.

In the present embodiment, information exchanges indicated by arrows S3 through S12 are conducted by employing the E-mail conformity with the SMTP (Simple Mail Transfer Protocol).

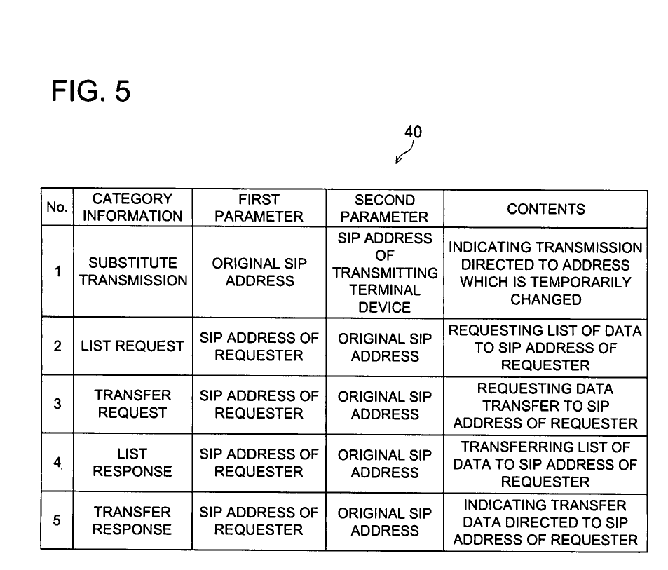

FIG. 5 shows a control data table 40 listing control data items to be attached to a header of each text of E-mails indicated by arrows S3 through S12 shown in FIG. 4. Each of the control data items is constituted by category data for indicating any one of the substitute transmission, the list request, the transfer request, the list response and the transfer response, a first parameter and a second parameter.

In the case of substitute transmission, the first parameter represents the terminal identifying information of the first receiving terminal device 10B being the original callee to which the caller originally intended to transmit the image data (for instance, SIP address), while the second parameter represents the terminal identifying information of the transmitting terminal device 10A being the caller. In the case of any one of the list request, the transfer request, the list response and the transfer response, the first parameter represents the terminal identifying information of the sender of request, while the second parameter represents the terminal identifying information of the first receiving terminal device 10B being the original callee to which the caller originally intended to transmit the image data.

For instance, in the case of substitute transmission, a character string formed in such a predetermined format as “@@@@ SUBSTITUTE TRANSMISSION, ORIGINAL SIP ADDRESS” is set at the headline of text of the E-mail. The receiver side checks whether or not the control data are attached to the headline of text of the E-mail, so as to conduct the controlling operation according to the control data, when the setting of the character string is detected.

Further, when the terminal device being capable of transmitting the list request and the transfer request is limited to only the first receiving terminal device 10B (namely, the terminal device being the original callee to which the caller originally intended to transmit the image data), since “the sender of request is equal to the original caller” can be established when the request from the third receiving terminal device 10D does not occur, it is applicable that each of the list request and the transfer request includes the first parameter only. Still further, irrespective of presence or absence of the abovementioned limitation, it is also applicable that the second parameter of “ORIGINAL SIP ADDRESS” is not necessary attached to each of the list request and the transfer request.

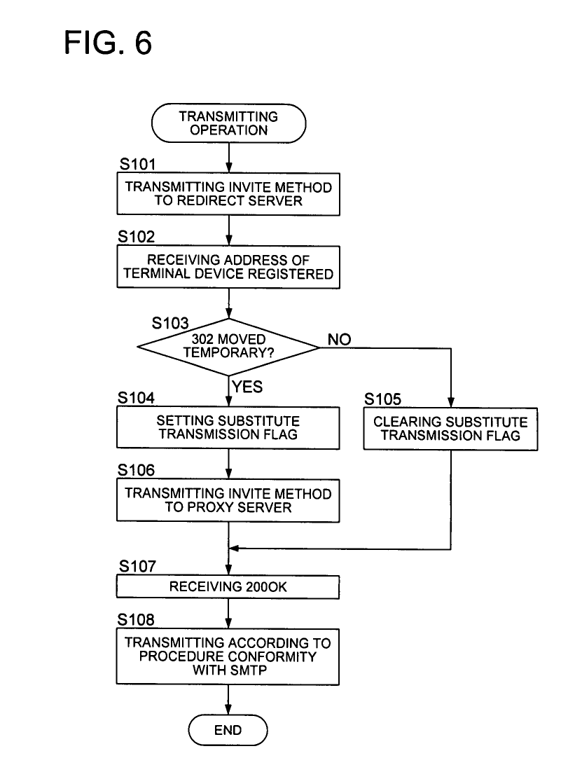

FIG. 6 shows a flowchart of the transmitting operation to be conducted by the transmitting terminal device 10A. When transmitting the image data, initially, the transmitting terminal device 10A inquires the IP address of the callee from the redirect server 34 while designating the SIP address of the callee (Step S101), and then, receives the address information returned in response to the inquiry (Step S102).

When the redirect setting (temporal change of the address) is established in the first receiving terminal device 10B serving as the callee, a code of 302MovedTenporary (serving as the redirect response) is returned to the caller as the response to the inquiry mentioned in the above. When receiving the code of 302MovedTenporary (Step S103; Yes), the transmitting terminal device 10A recognizes that the address of the first receiving terminal device 10B is temporarily changed, and sets a substitute transmission flag (Step S104).

Then, the transmitting terminal device 10A again sends the connection request with the INVITE method for connecting it to the address returned in the redirect response (in this example, the address of the second receiving terminal device 10C established as the redirect address of the first receiving terminal device 10B) to the proxy server 31 (Step S106). When the code of 2000K is returned from the second receiving terminal device 10C in response to the connection request sent from the caller (Step S107), the session is established. After that, the transmitting terminal device 10A conducts the image data transmitting operation according to the procedure conformity with the direct SMTP (Step S108). When the image data transmitting operation is completed, the session is opened by communicating the code of BYE/2000K between the caller and the callee as shown in FIG. 3, so as to finalize the consecutive transmitting processing.

On the other hand, when the contents received in Step S102 do not include 302MovedTenporary (Step S103; No), the transmitting terminal device 10A clears the substitute transmission flag (Step S105). Then, when the transmitting terminal device 10A receives 2000K (Step S107), the session between the transmitting terminal device 10A and the first receiving terminal device 10B is established. After that, the transmitting terminal device 10A transmits the image data to the first receiving terminal device 10B according to the procedure conformity with the direct SMTP (Step S108).

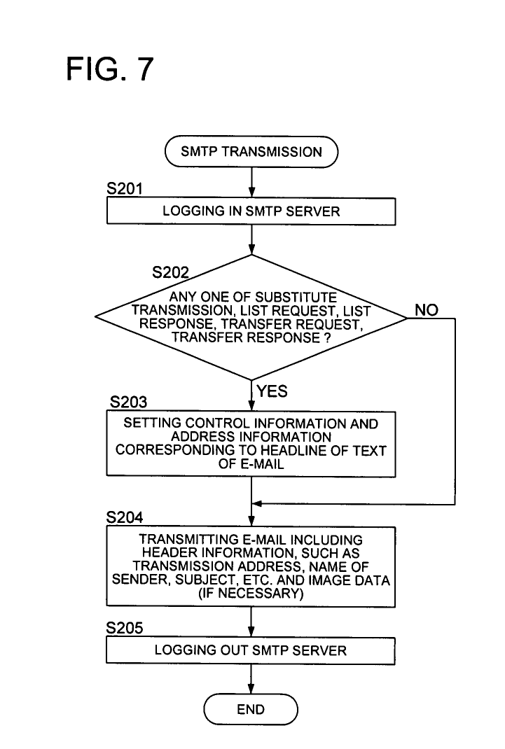

FIG. 7 shows a flowchart of the SMTP transmission processing to be conducted in each of the transmitting terminal device 10A, the first receiving terminal device 10B, the second receiving terminal device 10C and third receiving terminal device 10D when transmitting the E-mail. All of the transmitting operations employing the SMTP, such as the normal facsimile transmission, the substitute transmission, the transmission of the list request, the transmission of the list response, the transmission of the transfer request, the transmission of the transfer response, etc., are conducted according to the processing flow shown in FIG. 7.

At first, either the caller or the callee logs in to the SMTP server (Step S201), to determine whether the current transmission corresponds to any one of the substitute transmission, the transmission of the list request, the transmission of the list response, the transmission of the transfer request and the transmission of the transfer response or falls under a transmission other than the above (Step S202). When determining that the current transmission corresponds to any one of the substitute transmission, the transmission of the list request, the transmission of the list response, the transmission of the transfer request and the transmission of the transfer response (Step S202; Yes), the control data items (the category data, the first parameter and the second parameter) corresponding to the headline of the text of the E-mail are set (Step S203). When determining that the current transmission falls under, for instance, the normal facsimile transmission other than the substitute transmission, the transmission of the list request, the transmission of the list response, the transmission of the transfer request and the transmission of the transfer response (Step S202; No), the control data items are not set. Incidentally, either the normal transmission of the image data or the substitute transmission is determined on the basis of the status of the substitute transmission flag set or cleared in Step S104 or Step S105 shown in FIG. 6.

Next, either the caller or callee establishes header information, such as a transmission address, sender information, a subject, etc., and attaches the concerned image data to the E-mail when it corresponds to any one of the normal transmission of the image data, the substitute transmission and the transmission of the transfer response, and then, sends the E-mail (Step S204). After that, either the caller or callee logs out from the SMTP server so as to finalize the processing (Step S205).

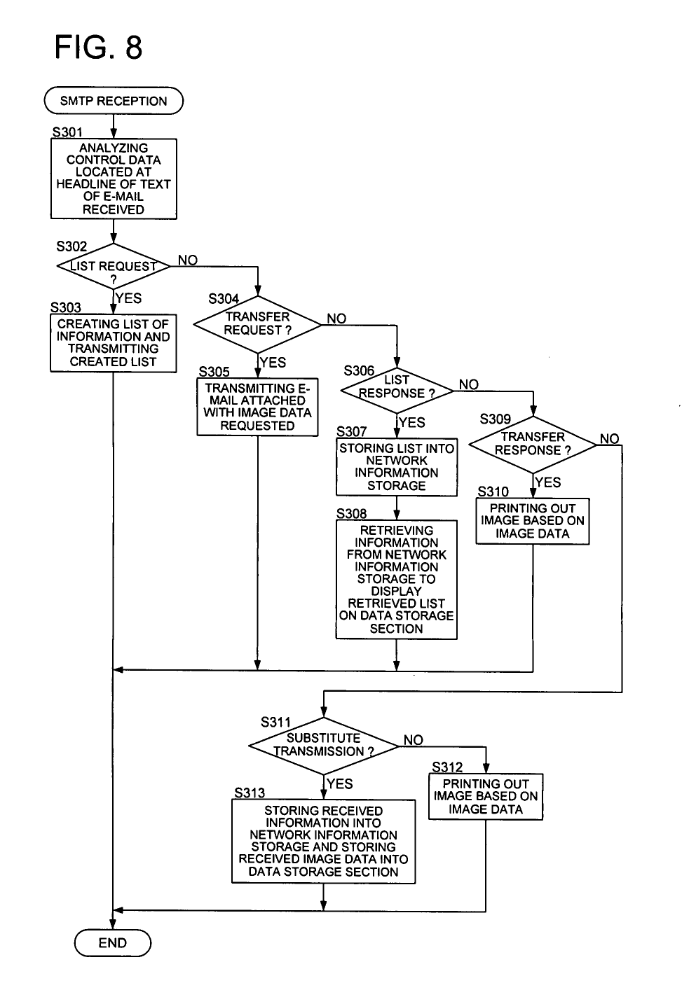

FIG. 8 shows a flowchart of the SMTP reception processing to be conducted in each of the first receiving terminal device 10B, the second receiving terminal device 10C, third receiving terminal device 10D, etc., when receiving the E-mail. When receiving the E-mail according to the SMTP, the callee analyzes the control data items located at the headline of the text of the E-mail received (Step S301), so as to conduct various kinds of operations based on the results of the above analyses. Concretely speaking, when receiving the list request (Step S1; Yes), the callee retrieves specific image data, whose original transmission address, which is originally addressed by the caller, coincides with the address represented by the terminal identifying information (SIP address) of the second parameter in the transfer request currently received, from various image data received in various substitute reception modes. Then, the callee creates a list of information in respect to the specific image data retrieved, and transmits the created list to the sender of the list request concerned (Step S303).

The list created as text data is described in the text of the E-mail. A character string, such as “@@@@ LIST RESPONSE OF ORIGINAL REQUESTER, ORIGINAL SIP ADDRESS”, etc., is described on the headline of text of the E-mail. The information in respect to the image data of “a date-and-time transmission SIP address, a number of pages included in the image data, a name of attached file” for all of the received data currently existing are described on the second line of text of the E-mail and the following lines.

For instance, in the example shown in FIG. 4, since the original callee is the first receiving terminal device 10B and its redirect address is the second receiving terminal device 10C, the E-mail of the list request is received by the second receiving terminal device 10C. When receiving the list request, the second receiving terminal device 10C retrieves the image data, whose original transmission address, originally addressed by the caller, coincides with the address of the first receiving terminal device 10B, from the various image data received in the various substitute reception modes, in order to create the list. Then, if the sender of the list request currently received is the first receiving terminal device 10B (Step S5 shown in FIG. 4), the second receiving terminal device 10C transmits the list response to the first receiving terminal device 10B (Step S6 shown in FIG. 4). Otherwise, if the sender of the list request currently received is the third receiving terminal device 10D (Step S9 shown in FIG. 4), the second receiving terminal device 10C transmits the same list response to the third receiving terminal device 10D (Step S10 shown in FIG. 4).

When receiving the transfer request (Step S304; Yes), the callee retrieves the image data, whose original transmission address originally addressed by the caller, coincides with the address represented by the terminal identifying information (SIP address) of the second parameter in the transfer request currently received, from the various image data received in the various substitute reception modes. Then, the callee transmits the E-mail attached with the retrieved image data to the sender of the transfer request concerned (Step S305).

The address picked up from the first parameter (SIP address of the original requester) described on the headline of text of the E-mail received as the transfer request is employed as the transmission address of the transfer response. A character strings of “@@@@ TRANSFER RESPONSE, SIP ADDRESS OF ORIGINAL REQUESTER, ORIGINAL SIP ADDRESS” are described on the headline of text of the E-mail to be transmitted as the transfer response and the E-mail attached with the image data is transmitted. When a plurality of image data sets are received, the above processing is repeated equivalent times to the number of the image data sets.

In the example shown in FIG. 4, the transfer request is received by the second receiving terminal device 10C. When receiving the transfer request, the second receiving terminal device 10C retrieves the image data, whose original transmission address, originally addressed by the caller, coincides with the address of the first receiving terminal device 10B, from the various image data received in the various substitute reception modes. Then, when the sender of the transfer request is the first receiving terminal device 10B, the second receiving terminal device 10C transmits the E-mail of the transfer response attached with the retrieved image data to the first receiving terminal device 10B, while when the sender of the transfer request is the third receiving terminal device 10D, the second receiving terminal device 10C transmits the E-mail of the same transfer response attached with the retrieved image data to the third receiving terminal device 10D.

When receiving the list response (Step S306; Yes), the callee stores the list included in the list response into the network information storage 17 (Step S307), and displays the stored list on the data storage section 15 (Step S308). For instance, when the user selects a desired image data from the list, the callee transmits the transfer request, in which the desired image data is designated as an object of transmission, to the sender of the list response previously received. Then, the terminal device, which received the above transfer request, sends the image data designated as the object of transmission back to the callee concerned. Accordingly, it becomes possible to acquire the image data, selected from the list, from the terminal device located remote form the callee concerned.

When receiving the transfer response (Step S309; Yes), the callee prints out an image based on the image data included in the transfer response (Step S310). Incidentally, it is also applicable that the callee stores the transfer response including the image data into storage in response to instructions or setting of the user.

In the case of the substitute transmission (Step S311; Yes), the callee stores the received image data into the data storage section 15 without printing the image based on the image data. Further, the callee stores the information in respect to the received image data into the network information storage 17 (Step S313). Namely, since the image data and the information received in the substitute reception mode are originally directed to the other callee, the callee, which currently received the image data in the substitute reception mode, stores them in storage without conducting the printout operation of the image data.

When the E-mail does not correspond to any one of the list request, the transfer request, the list response, the transfer response and the substitute transmission (Step S311; No), the E-mail includes the image data to be received in the normal facsimile transmission. Accordingly, the callee prints out an image based on the image data received (Step S312).

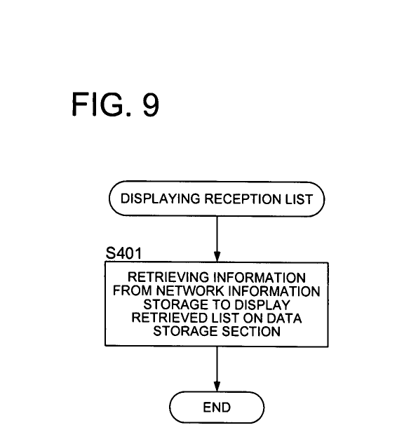

FIG. 9 shows a flowchart of processing for displaying a reception list on the operational display section 14 of the second receiving terminal device 10C. According to this flowchart, the callee reads out the information in respect to the image data received in the substitute reception mode, which is stored in the network information storage 17 in Step S313 shown in FIG. 8, so as to display them on the operational display section 14 (Step S401).

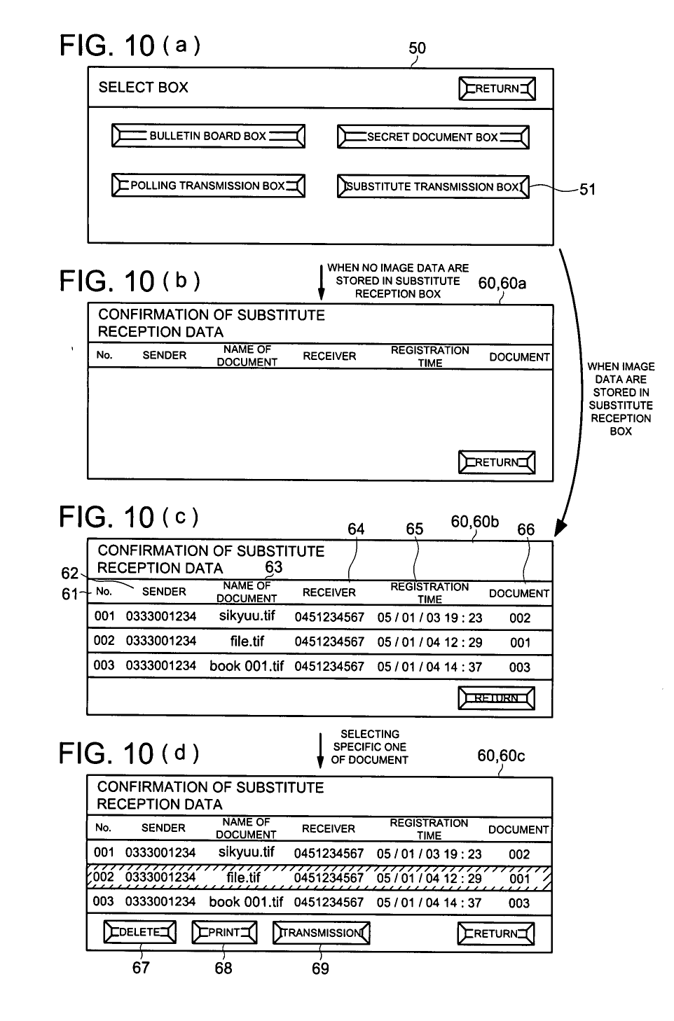

FIG. 10(a), FIG. 10(b), FIG. 10(c) and FIG. 10(d) show exemplified screens to be displayed on the operational display section 14, when displaying the information in respect to the image data received in the substitute transmission, or printing an image represented by the image data. The second receiving terminal device 10C stores the image data received in the substitute reception mode into a storage area called a substitute reception box. At first, the user conducts predetermined operations so as to display a box selecting screen 50, shown in FIG. 10(a), on the operational display section 14. Then, when the user pushes down a substitute reception box button 51 provided in the box selecting screen 50, the screen is changed to a substitute reception confirmation screen 60 in which the list of information in respect to the image data stored in the substitute reception box is displayed.

FIG. 10(b) shows a first substitute reception confirmation screen 60a to be displayed when no image data are stored in the substitute reception box, while FIG. 10(c) shows a second substitute reception confirmation screen 60b to be displayed when image data are actually stored in the substitute reception box. With respect to each of the image data sets, a management number 61 effective in the substitute reception box, caller terminal identifying information 62, a document name 63, callee terminal identifying information 64, registration time (reception time) 65, a number of pages 66, etc. are displayed on the substitute reception confirmation screen 60.

As indicated in a third substitute reception confirmation screen 60c shown in FIG. 10(d), when the user pushes down a desired line among the lines listed on the second substitute reception confirmation screen 60b to select the desired image data, a display mode of the selected line is changed (in FIG. 10(d), indicated by slanted lines). At the same time, a delete button 67, a print button 68 and a transmission button 69 emerge at the lower area of the screen. By operating the delete button 67, the print button 68 or the transmission button 69, it becomes possible for the user to print an image based on the currently selected image data (when the print button 68 is pushed down), to transmit the currently selected image data to another network facsimile apparatus 10 (when the transmission button 69 is pushed down) and to delete the currently selected image data (when the print button 68 is pushed down).

Incidentally, when receiving the list response, the first receiving terminal device 10B or the third receiving terminal device 10D displays the list based on the list response in the same screen as shown in FIG. 10(c). Then, by selecting desired image data from the list, the transfer request in which the selected image data is designated as the object of transfer is transmitted to the second receiving terminal device 10C.

Although, referring to the drawings, the embodiments of the present invention have been detailed in the foregoing, the scope of the present invention is not limited to the aforementioned embodiments. Further, modifications and additions applied to the disclosed embodiments by a skilled person without departing from the spirit and scope of the invention shall be included in the scope of the present invention.

For instance, in the aforementioned embodiment, when conducting the substitute transmission, the information indicating the substitute transmission and the terminal identifying information (original SIP address) of the first receiving terminal device 10B are separately attached to the headline of text of the E-mail. However, it is also applicable that the terminal identifying information of the first receiving terminal device 10B also serve as the information indicating the substitute transmission or vice versa. In other words, it is applicable that the fact that the terminal identifying information of the first receiving terminal device 10B is attached to the headline of text of the E-mail represents that the current communication mode is the substitute transmission.

Further, although the SMTP is employed for conducting the substitute transmission or for transmitting the list request in the aforementioned embodiment, a certain communication method other than the SMTP could be employed for this purpose. Further, it is applicable that the method for adding the control data is changed corresponding to the communication method as needed. The combination of the parameters, employed as the control data in the aforementioned embodiment, are merely a sample combination. Accordingly, it is applicable that more information is added to the control data as an additional parameter. For instance, when transmitting the image data in the substitute transmission mode, authentication information (such as a password, etc.) for authenticating the right for printing an image represented by the image data and/or transmitting the transfer request is added to the control data, so as to limit the printing and/or the transferring operations within a range authenticated by the authentication information. This will contribute an improvement of the security.

Incidentally, the redirect address to be designated by the first receiving terminal device 10B is not limited to a single address, but a plurality of redirect addresses can be designated by the first receiving terminal device 10B. In this case, one of the plurality of redirect addresses could be employed as the destination of the list request and the transfer request.

Further, each of the third receiving terminal device 10D and the second receiving terminal device 10C is not necessarily provided with the function for reading the document, the function for printing an image, etc. For instance, it is applicable that the second receiving terminal device 10C to be designated as the redirect address is such a facsimile server that is capable of accumulating the transferred image data in it.

According to the network facsimile apparatus and the network facsimile system embodied in the present invention, it becomes possible to alleviate burdens to be incurred to the user in charge of operations for confirming the transferring status and for acquiring the image data when the image data are transferred to another receiver by employing the redirect function.

While the preferred embodiments of the present invention have been described using specific term, such description is for illustrative purpose only, and it is to be understood that changes and variations may be made without departing from the spirit and scope of the appended claims.

What is claimed is:

1. A network facsimile apparatus that conducts a session controlling operation based on a Session Initiation Protocol;
when a first reception terminal device is incapable of receiving image data sent from the network facsimile apparatus serving as a transmission terminal device, the network facsimile apparatus comprising:
a receiving section to receive a terminal identifying information in respect to the transmission terminal device, a first terminal identifying information in respect to the first reception terminal device and the image data; and
a display section to display the terminal identifying information in respect to the transmission terminal device and the first terminal identifying information in respect to the first reception terminal device.

2. The network facsimile apparatus of claim 1,
wherein the first terminal identifying information in respect to the first reception terminal device include substitute transmission indicating information, which indicate that a current transmission is a substitute transmission.

3. A network facsimile apparatus that conducts a session controlling operation based on a Session Initiation Protocol;
when a first reception terminal device is incapable of receiving image data sent from the network facsimile apparatus serving as a transmission terminal device, the network facsimile apparatus comprising:
a transmitting section to transmit a terminal identifying information in respect to the transmission terminal device and a first terminal identifying information in respect to the first reception terminal device and the image data to a second reception terminal device.

4. The network facsimile apparatus of claim 3, further comprising:
a determining section to determine whether or not the first reception terminal device receives the image data sent from the transmission terminal device, based on a response, sent from a SIP server, for a connection request to the first reception terminal device.

5. The network facsimile apparatus of claim 3, wherein the first terminal identifying information in respect to the first reception terminal device include substitute transmission indicating information, which indicate that a current transmission is a substitute transmission.

6. A network facsimile apparatus that conducts a session controlling operation based on a Session Initiation Protocol;
when a first reception terminal device is incapable of receiving image data sent from a transmission terminal device, the network facsimile apparatus comprising:
a receiving section to receive a terminal identifying information in respect to the transmission terminal device, substitute transmission indicating information indicating that a current transmission is a substitute transmission and the image data; and
a control section to conduct controlling operation for storing the image data into a storage section based on the substitute transmission indicating information received by the receiving section without printing an image represented by the image data.

7. The network facsimile apparatus of claim 6,
wherein the substitute transmission indicating information include the first terminal identifying information in respect to the first reception terminal device.

8. A network facsimile apparatus that conducts a session controlling operation based on a Session Initiation Protocol;
when a first reception terminal device is incapable of receiving image data sent from the network facsimile apparatus serving as a transmission terminal device, the network facsimile apparatus comprising:
a transmitting section to transmit a terminal identifying information in respect to the transmission terminal device, substitute transmission indicating information indicating that a current transmission is a substitute transmission and the image data to a second reception terminal device.

9. The network facsimile apparatus of claim 8, further comprising:
a determining section to determine whether or not the first reception terminal device receives the image data sent from the transmission terminal device, based on a response, sent from a SIP server, for a connection request to the first reception terminal device.

10. The network facsimile apparatus of claim 8,
wherein the substitute transmission indicating information include the first terminal identifying information in respect to the first reception terminal device.

11. A network facsimile apparatus that conducts a session controlling operation based on a Session Initiation Protocol;
when a first reception terminal device is incapable of receiving image data sent from a transmission terminal device, the network facsimile apparatus comprising:
a receiving section to receive a terminal identifying information in respect to the transmission terminal device, a first terminal identifying information in respect to the first reception terminal device and the image data; and
a transmitting section to transmit information of the image data, which relate to the first terminal identifying information in respect to the first reception terminal device, to the first reception terminal device, in response to a signal sent from the first reception terminal device.

12. The network facsimile apparatus of claim 11,
wherein the first terminal identifying information in respect to the first reception terminal device include substitute transmission indicating information, which indicate that a current transmission is a substitute transmission.

13. A network facsimile apparatus that conducts a session controlling operation based on a Session Initiation Protocol;
when a first reception terminal device is incapable of receiving image data sent from a transmission terminal device, the network facsimile apparatus comprising:
a receiving section to receive a terminal identifying information in respect to the transmission terminal device, a first terminal identifying information in respect to the first reception terminal device and the image data; and
a transmitting section to transmit information of the image data, which relate to the first terminal identifying information in respect to the first reception terminal device, to a third reception terminal device, in response to a signal sent from the third reception terminal device.

14. The network facsimile apparatus of claim 13,
wherein the first terminal identifying information in respect to the first reception terminal device include substitute transmission indicating information, which indicate that a current transmission is a substitute transmission.

15. A network facsimile apparatus that conducts a session controlling operation based on a Session Initiation Protocol;
when a first reception terminal device is incapable of receiving image data sent from a transmission terminal device, the network facsimile apparatus comprising:
a receiving section to receive a terminal identifying information in respect to the transmission terminal device, a first terminal identifying information in respect to the first reception terminal device and the image data; and
a transmitting section to transmit the image data, which relate to the first terminal identifying information in respect to the first reception terminal device, to the first reception terminal device, in response to a signal sent from the first reception terminal device.

16. The network facsimile apparatus of claim 15,
wherein the first terminal identifying information in respect to the first reception terminal device include substitute transmission indicating information, which indicate that a current transmission is a substitute transmission.

17. A network facsimile apparatus that conducts a session controlling operation based on a Session Initiation Protocol;
when a first reception terminal device is incapable of receiving image data sent from a transmission terminal device, the network facsimile apparatus comprising:
a receiving section to receive a terminal identifying information in respect to the transmission terminal device, a first terminal identifying information in respect to the first reception terminal device and the image data; and
a transmitting section to transmit the image data, which relate to the first terminal identifying information in respect to the first reception terminal device, to a third reception terminal device, in response to a signal sent from the third reception terminal device.

18. The network facsimile apparatus of claim 17,
wherein the first terminal identifying information in respect to the first reception terminal device include substitute transmission indicating information, which indicate that a current transmission is a substitute transmission.

19. A network facsimile apparatus that conducts a session controlling operation based on a Session Initiation Protocol;
when a first reception terminal device is incapable of receiving image data sent from a transmission terminal device, the network facsimile apparatus comprising:
a request signal transmitting section to transmit a request signal for transmitting information of the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device, in it.

20. The network facsimile apparatus of claim 19,
wherein the first terminal identifying information in respect to the first reception terminal device is a terminal identifying information of itself; and
wherein the request signal transmitting section transmits the request signal, when the first reception terminal device becomes receivable.

21. A network facsimile apparatus that conducts a session controlling operation based on a Session Initiation Protocol;
when a first reception terminal device is incapable of receiving image data sent from a transmission terminal device, the network facsimile apparatus comprising:
a request signal transmitting section to transmit a request signal for transmitting the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device in it.

22. The network facsimile apparatus of claim 21,
wherein the first terminal identifying information in respect to the first reception terminal device is a terminal identifying information of itself; and
wherein the request signal transmitting section transmits the request signal, when the first reception terminal device becomes receivable.

23. A network facsimile apparatus that conducts a session controlling operation based on a Session Initiation Protocol;
when the network facsimile apparatus serving as a first reception terminal device is incapable of receiving image data sent from a transmission terminal device, the network facsimile apparatus comprising:
a request signal transmitting section to transmit a request signal for transmitting information of the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device, in it.

24. The network facsimile apparatus of claim 23, further comprising:
a state distinction section to distinguish whether or not the first reception terminal device is currently receivable;
a display section displays a distinguished result determined by the state distinction section; and
an accepting section to accept an instruction for making the request signal transmitting section transmit the request signal, inputted by a user who observes the distinguished result displayed on the display section;
wherein the request signal transmitting section transmits the request signal, when the accepting section accepts the instruction.

25. The network facsimile apparatus of claim 23, further comprising:
an inputting section to accept terminal identifying information inputted by a user;
wherein the first terminal identifying information in respect to the first reception terminal device are inputted from the inputting section.

26. The network facsimile apparatus of claim 23,
wherein the request signal transmitting section transmits the request signal, when the first reception terminal device becomes receivable.

27. The network facsimile apparatus of claim 26, further comprising:
a state distinction section to distinguish whether or not the first reception terminal device is currently receivable;
wherein, when the state distinction section determines that the first reception terminal device is currently receivable, the request signal transmitting section automatically transmits the request signal for transmitting the image data.

28. The network facsimile apparatus of claim 27,
wherein, even when determining that the first reception terminal device is currently receivable, transmission of the request signal is banned, based on setting information of the first reception terminal device.

29. A network facsimile apparatus that conducts a session controlling operation based on a Session Initiation Protocol;
when the network facsimile apparatus serving as a first reception terminal device is incapable of receiving image data sent from a transmission terminal device, the network facsimile apparatus comprising:
a request signal transmitting section to transmit a request signal for transmitting the image data, which relate to a first terminal identifying information in respect to the first reception terminal device, to a second reception terminal device, which is currently storing a terminal identifying information in respect to the transmission terminal device, the first terminal identifying information in respect to the first reception terminal device and the image data, received from the transmission terminal device in it.

30. The network facsimile apparatus of claim 29, further comprising:
a state distinction section to distinguish whether or not the first reception terminal device is currently receivable;
a display section displays a distinguished result determined by the state distinction section; and
an accepting section to accept an instruction for making the request signal transmitting section transmit the request signal, inputted by a user who observes the distinguished result displayed on the display section;
wherein the request signal transmitting section transmits the request signal, when the accepting section accepts the instruction.

31. The network facsimile apparatus of claim 29, further comprising:
an inputting section to accept terminal identifying information inputted by a user;
wherein the first terminal identifying information in respect to the first reception terminal device are inputted from the inputting section.

32. The network facsimile apparatus of claim 29,
wherein the request signal transmitting section transmits the request signal, when the first reception terminal device becomes receivable.

33. The network facsimile apparatus of claim 32, further comprising:
a state distinction section to distinguish whether or not the first reception terminal device is currently receivable;
wherein, when the state distinction section determines that the first reception terminal device is currently receivable, the request signal transmitting section automatically transmits the request signal for transmitting the image data.

34. The network facsimile apparatus of claim 33,
wherein, even when determining that the first reception terminal device is currently receivable, transmission of the request signal is banned, based on setting information of the first reception terminal device.

35. A network facsimile system, comprising:
a transmission terminal apparatus serving as a caller;
a first reception terminal apparatus serving as a first callee; and
a second reception terminal apparatus serving as a second callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, a first terminal identifying information in respect to the first callee and the image data to the second callee, when the determining section determines that the first callee is incapable of receiving the image data; and
wherein the second callee includes:
a receiving section to receive the terminal identifying information in respect to the caller, the first terminal identifying information in respect to the first callee and the image data; and
a display section to display the terminal identifying information in respect to the caller and the first terminal identifying information in respect to the first callee, received by the receiving section.

36. A network facsimile system, comprising:
a transmission terminal apparatus serving as a caller;
a first reception terminal apparatus serving as a first callee; and
a second reception terminal apparatus serving as a second callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, substitute transmission indicating information, which indicate that a current transmission is a substitute transmission and the image data to the second callee, when the determining section determines that the first callee is incapable of receiving the image data; and
wherein the second callee includes:
a receiving section to receive the terminal identifying information in respect to the caller, the substitute transmission indicating information and the image data; and
wherein the second callee includes:
a storage section to store the image data in it; and
a control section to store the image data into the storage section based on the substitute transmission indicating information received by the receiving section without printing an image represented by the image data.

37. A network facsimile system, comprising:
a transmission terminal apparatus serving as a caller;
a first reception terminal apparatus serving as a first callee; and
a second reception terminal apparatus serving as a second callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, a first terminal identifying information in respect to the first callee and the image data to the second callee, when the determining section determines that the first callee is incapable of receiving the image data; and
wherein the second callee includes:
a receiving section to receive the terminal identifying information in respect to the caller, the first terminal identifying information in respect to the first callee and the image data; and
wherein the first callee includes:
a request signal transmitting section to transmit a request signal for transmitting information of the image data, which relate to the first terminal identifying information in respect to the first callee, to the second callee; and
wherein the second callee further includes:
a transmitting section to transmit the information of the image data, which relate to the first terminal identifying information in respect to the first callee, to the first callee in response to the request signal sent from the first callee.

38. The network facsimile system of claim 37,
wherein the first callee further includes:
a display section to display a distinguished result determined by the state distinction section; and
an accepting section to accept an instruction for making the request signal transmitting section transmit the request signal, inputted by a user who observes the distinguished result displayed on the display section;
wherein the request signal transmitting section transmit the request signal, when the accepting section accepts the instruction.

39. The network facsimile system of claim 37,
wherein the first callee further includes:
a state distinction section to distinguish whether or not the first callee itself is currently capable of receiving the image data; and
wherein, when the state distinction section determines that the first callee is currently capable of receiving the image data, the request signal transmitting section transmits the request signal.

40. The network facsimile system of claim 39,
wherein, even when the state distinction section determines that the first callee is currently capable of receiving the image data, the first callee bans an operation for transmitting the request signal, based on setting information of the first callee.

41. A network facsimile system, comprising:
a transmission terminal apparatus serving as a caller;
a first reception terminal apparatus serving as a first callee;
a second reception terminal apparatus serving as a second callee; and
a third reception terminal apparatus serving as a third callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, a first terminal identifying information in respect to the first callee and the image data to the second callee, when the determining section determines that the first callee is incapable of receiving the image data; and
wherein the second callee includes:
a receiving section to receive the terminal identifying information in respect to the caller, the first terminal identifying information in respect to the first callee and the image data; and
wherein the third callee includes:
an inputting section to input the first terminal identifying information in respect to the first callee; and
a request signal transmitting section to transmit a request signal for transmitting information of the image data, which relate to the first terminal identifying information in respect to the first callee, to the second callee; and
wherein the second callee further includes:
a transmitting section to transmit the information of the image data, which relate to the first terminal identifying information in respect to the first callee, to the third callee in response to the request signal sent from the third callee.

42. A network facsimile system, comprising:
a transmission terminal apparatus serving as a caller;
a first reception terminal apparatus serving as a first callee; and
a second reception terminal apparatus serving as a second callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, a first terminal identifying information in respect to the first callee and the image data to the second callee, when the determining section determines that the first callee is incapable of receiving the image data; and
wherein the second callee includes:
a receiving section to receive the terminal identifying information in respect to the caller, the first terminal identifying information in respect to the first callee and the image data; and
wherein the first callee includes:
a request signal transmitting section to transmit a request signal for transmitting the image data, which relate to the first terminal identifying information in respect to the first callee, to the second callee; and
wherein the second callee further includes:
a transmitting section to transmit the image data, which relate to the first terminal identifying information in respect to the first callee, to the first callee in response to the request signal sent from the first callee.

43. The network facsimile system of claim 42,
wherein the first callee further includes:
a display section to display a distinguished result determined by the state distinction section; and
an accepting section to accept an instruction for making the request signal transmitting section transmit the request signal, inputted by a user who observes the distinguished result displayed on the display section;
wherein the request signal transmitting section transmit the request signal, when the accepting section accepts the instruction.

44. The network facsimile system of claim 42,
wherein the first callee further includes:
a state distinction section to distinguish whether or not the first callee itself is currently capable of receiving the image data; and
wherein, when the state distinction section determines that the first callee is currently capable of receiving the image data, the request signal transmitting section transmits the request signal.

45. The network facsimile system of claim 44,
wherein, even when the state distinction section determines that the first callee is currently capable of receiving the image data, the first callee bans an operation for transmitting the request signal, based on setting information of the first callee.

46. A network facsimile system, comprising:
a transmission terminal apparatus serving as a caller;
a first reception terminal apparatus serving as a first callee;
a second reception terminal apparatus serving as a second callee; and
a third reception terminal apparatus serving as a third callee;
wherein each of the transmission terminal apparatus, the first reception terminal apparatus and the second reception terminal apparatus establishes a session based on a Session Initiation Protocol to conduct image data communicating operations with any of other apparatuses, including the caller, the first callee and the second callee, coupled to the network facsimile system: and
wherein the caller includes:
a determining section to determine whether or not the first callee is capable of receiving the image data sent form the caller itself; and
a transmitting section to transmit a terminal identifying information in respect to the caller, a first terminal identifying information in respect to the first callee and the image data to the second callee, when the determining section determines that the first callee is incapable of receiving the image data; and
wherein the second callee includes:
a receiving section to receive the terminal identifying information in respect to the caller, the first terminal identifying information in respect to the first callee and the image data; and
wherein the third callee includes:
an inputting section to input the first terminal identifying information in respect to the first callee; and
a request signal transmitting section to transmit a request signal for transmitting the image data, which relate to the first terminal identifying information in respect to the first callee, to the second callee; and
wherein the second callee further includes:
a transmitting section to transmit the image data, which relate to the first terminal identifying information in respect to the first callee, to the third callee in response to the request signal sent from the third callee.
